(19) United States
(12) Patent Application Publication
(10) Pub. No.: US 2024/0024855 A1
(43) Pub. Date: Jan. 25, 2024

(54) METHODS FOR PREPARING A CATALYTIC CONVERTER BY DISPLACEMENT OF WATER GAS AT HIGH TEMPERATURE AND METHOD FOR REDUCING CARBON MONOXIDE CONTENT

(71) Applicant: PETRÓLEO BRASILEIRO S.A. – PETROBRAS, Rio de Janeiro (BR)

(72) Inventors: Roberto Carlos PONTES BITTENCOURT, Rio de Janeiro (BR); Anilza DE ALMEIDA LYRA CORREA, Rio de Janeiro (BR)

(21) Appl. No.: 18/256,538

(22) PCT Filed: Nov. 23, 2021
(86) PCT No.: PCT/BR2021/050514

§ 371 Date: Jun. 8, 2023

(30) Foreign Application Priority Data
Dec. 9, 2020 (BR) 102020025161-9

(51) Int. Cl. B01J 23/06; B01J 21/04; B01J 37/02; B01J 37/10; B01J 35/10; C01B 3/16

(52) U.S. Cl. CPC B01J 23/06; B01J 21/04; B01J 37/0205; B01J 37/024; B01J 37/0236; B01J 37/10; B01J 35/1038; B01J 35/1014; C01B 3/16; C01B 2203/0283; C01B 2203/1082; C01B 2203/1076

(57) ABSTRACT

The present invention deals with a catalyst for converting CO by the reaction of water gas shift at high temperature, free of chromium and iron, consisting of alumina promoted by potassium and zinc oxide. The catalyst prepared in this way maintains a high CO conversion activity, not having the environmental or operating limitations with low excess steam in the process, which exist for state of the art catalysts. Such a catalyst is used in the process of producing hydrogen or synthesis gas by steam reforming hydrocarbons, allowing the use of low steam/carbon ratios in the process, presenting high activity and stability to thermal deactivation and lower environmental restrictions on production, storage, use and disposal, than catalysts used industrially based on iron, chromium and copper oxides.

### FIELD OF THE INVENTION

The present invention deals with methods for preparing a water gas shift catalyst at high temperature, free of chromium and iron or noble metals, in which they are used in the process for converting carbon monoxide (CO), applied in H2 production units, aiming to maintain the high CO conversion activity, not having the environmental limitations or operation with low excess of steam in the process.

### DESCRIPTION OF THE STATE OF THE ART

The water gas shift reaction (“water gas shift”) is an integral step in the steam reforming process for hydrogen production. The reaction can be represented by equation 1, being exothermic and typically limited by thermodynamic equilibrium.

CO+H₂O=CO₂+H₂ (eq.1)

The reaction produces H2 and, simultaneously, reduces the level of CO, which is a contaminant for the catalysts used in the ammonia synthesis processes, hydrotreatment and for use in fuel cells, which make use of high purity hydrogen. In synthesis gas generation processes, the “water gas shift” reaction is used to adjust the desired proportion of CO and H2. The “water gas shift” reaction is also part of other H2 production processes, such as partial oxidation and autothermal reforming.

In the steam reforming process, the “water gas shift” reaction is carried out in a first stage, called “High Temperature Shift” (HTS), which catalyst operates at typical temperatures between 330° C. at the inlet and up to 450° C. at the reactor outlet, followed by cooling of the effluent stream and additional reaction in a second stage, called “Low Temperature Shift” (LTS), which catalyst operates at typical temperatures between 180° C., at the inlet, and 240° C. at the reactor outlet. In a variation of the process configuration, the LTS reactor and the subsequent amine CO2 separation system is replaced by the “pressure swing adsorption” (PSA) process. The pressure conditions are dictated by the use of hydrogen, typically the process pressure is between 10 and 40 bar.

Commercial LTS catalysts are made up of copper oxide, zinc oxide and alumina, with typical contents between 40 and 35% m/m; 27 to 44% m/m with alumina as balance, respectively. They may also contain minor amounts of alkaline promoters, such as cesium (Cs) or potassium (K). LTS catalysts lose activity quickly when exposed to high temperature, the reason why they are used in the typical temperature range of 180° C. to 240° C., or in its “Medium Temperature Shift” (MTS) version at temperatures from 180° C. to 330° C. The lower temperature of the utilization range is normally dictated by the requirement that steam condensation does not occur in the reactor at the operating pressure of the unit.

The HTS catalyst used industrially in large-scale units, considered here as units with a production of more than 50,000 Nm3/d of hydrogen, is made up of iron (Fe), chromium (Cr) and copper (Cu), mostly in the form of oxides before the catalyst starts operating. Although widely used, the catalyst formulation has the disadvantage of containing chromium in its formulation. Particularly, during the calcination steps for manufacturing this catalyst, it is inevitable that variable levels of chromium in oxidation state VI (CrO₃ or Cr⁶⁺) form, a compound that has known carcinogenic effects and damage to the environment, being subject to worldwide increasing rigor of legislation. As an example, the rules governing exposure in the workplace to Cr⁶⁺ by OSHA (US Occupation Health and Safety Organization) can be mentioned. The presence of Cr⁶⁺ has negative impacts on the manufacturing process, handling, transportation, loading, unloading and disposal of the material. Therefore, teaching a chromium-free HTS catalyst in its formulation is desirable.

The literature reports several studies for replacing chromium in the formulation of STH catalyst with iron, chromium and copper-based composition. In a review of the literature, studies on the replacement of chromium by various elements are reported, such as cerium, silicon, titanium, magnesium, zirconium and aluminum oxides, with aluminum being the most studied element, in accordance with the reference by PAL, D. B. et al. “Performance of water gas shift reaction catalysts. A review”, Renewable and Sustainable Energy Reviews, v. 93, p. 549-565, 2018. However, in industrial practice, an efficient substitute for chromium cannot be found yet, which has the desired property of reducing the loss of surface area of the iron oxide phases present in the catalyst at the usual process temperatures and consequently reduces the rate of material deactivation.

Another unfavorable characteristic of the current formulation of HTS catalysts is the presence of iron oxides in their composition, which typically make up 80 to 90% m/m of the catalyst. The iron oxide present in the HTS catalyst is mostly in the form of hematite (Fe₂O₃), in addition to minor amounts of other iron hydroxides. After being loaded into the reactor, the catalyst undergoes an activation procedure, which reduces the hematite phase (Fe₂O₃) to the magnetite phase (Fe₃O₄), which in turn forms the active phase of the catalyst. Simultaneously, during the reduction, the CuO phases are reduced to metallic copper. The reactions are exemplified below:

3Fe₂O₃+H₂=2Fe₃O₄+H₂O (eq.2)

CuO+H₂=Cu+H₂O

The activation procedure must be carefully carried out, so that excessive reduction of the iron oxide phases does not occur, which could then form the undesirable FeO or even metallic Fe phases, leading to several problems such as reduced activity, disintegration of the catalyst with increased pressure drop in the reactor and formation of by-products by the “Fischer-Tropsch” reaction or by the methanation reaction. Thus, from an industrial point of view, an HTS catalyst that does not require the reduction procedure or even could be heated with a gas containing high levels of H2, but free of moisture, would be desirable.

Once the Fe₃O₄ phase is formed, its stability under industrial conditions will depend on the ratio between the oxidizing and reducing components present in the reactor feed, particularly the H₂O/H₂ and CO₂/CO ratios. The literature teaches that when the steam content in the process is reduced below a certain value, usually expressed as the steam/carbon ratio in the previous reforming step, the iron oxide phases transform into undesirable iron carbide-type phases. The iron carbide phases, in turn, lead to the formation of by-products such as hydrocarbons, alcohols and other compounds, which reduce the hydrogen yield and bring additional difficulties in purifying the hydrogen produced and the steam condensed in the process. Thus, it is desirable to teach an HTS catalyst free of iron in its composition.

A solution taught in U.S. Pat. No. 6,500,403 to reduce excess steam in the H2 production process by steam reforming would be to carry out the water gas shift reaction in a first step, at temperatures between 280° C. and 370° C., using an iron-free and copper-based catalyst on a support, thus reducing the CO/CO₂ ratio at the entrance of the second stage, which would be carried out on a conventional Fe/Cr type catalyst, at a typical temperature of 350° C. to 500° C. This solution, however, adds high additional costs to the steam reforming process, as it includes an additional CO abatement step, or charge cooling steps followed by heating, which brings energy losses and/or greater process complexity.

A solution that proves to be more practical to avoid the formation of iron carbide phases in the HTS catalyst is taught in U.S. Pat. No. 4,861,745. This patent describes the addition of copper oxide to the HTS catalyst formulation, consisting of iron and chromium oxides. In accordance with this teaching, commercial HTS catalysts used in large-scale H2 production units are made up of iron, chromium and copper oxides. However, this solution can only be used up to a minimum vapor/carbon ratio of around 2.8 mol/mol. Thus, steam is still used in large excess in relation to the stoichiometry of the shift reaction (eq.3), which brings the undesirable effect of a high energy expenditure in the process, in addition to greater CO₂ emissions due to the burning of fuel for provide the energy needed to heat excess steam.

CH₄+H₂O=3H₂+CO (eq.3)

CₓH_{y}+xH₂O=(y+2x)/2H₂+xCO

Another solution taught in the literature to produce an iron-free HTS catalyst in its formulation is the use of noble metals. RATNASAMY, C.; Wagner, J. P. “Water gas shift catalysis”, Catalysis Reviews, V. 51, p. 325-440, 2009 reviews the literature and teaches the use of platinum (Pt) deposited on various oxides, such as zirconium, vanadium, alumina and cerium oxides. These catalysts are sometimes used in fuel cell systems, however, they are of limited use in large units for H2 production, due to the high cost and reduced availability of noble metals. Another negative factor is that these catalysts are much more sensitive to the presence of poisons in the reactor feed, such as chlorides or sulfur, than traditional HTS catalysts based on iron, chromium and copper oxides.

Documents U.S. Pat. Nos. 7,998,897, 8,111,9099 and WO2018/134162A1 teach a HTS catalyst free of Fe and Cr in its formulation. The catalyst is a mixture of zinc aluminate (ZnAl₂O₄) and zinc oxide (ZnO), with a Zn/Al molar ratio between 0.5 to 1.0, in combination with alkali metals selected from the group consisting of Na, K, Rb, Cs and mixtures thereof, in a content between 0.4 to 8.0% m/m, based on the oxidized material. In particular, the invention U.S. Pat. No. 7,998,898 teaches a catalyst with a Zn/Al molar ratio of 0.7, containing 34 to 35% m/m of Zn and 7 to 8% of Cs. However, doubts remain about the activity and stability of this type of material.

Therefore, it is desirable to provide a HTS catalyst that is free of chromium (Cr), an element dangerous to health and the environment, free of iron (Fe) so that a reduced excess of steam can be used in the process, with gains in efficiency, energy, but which has high activity and stability under the conditions of the steam reforming process, thus allowing replacement of the current HTS catalysts in existing units.

U.S. Pat. No. 7,964,114B2 relates to the development of a catalyst for use in water gas exchange processes, a method for manufacturing the catalyst and a method for using the catalyst. The catalyst is composed of iron oxide, copper oxide, zinc oxide, alumina and, optionally, potassium oxide. Furthermore, the catalyst demonstrates surprising activity for the conversion of carbon monoxide under high to moderate temperature reaction conditions. However, it uses iron oxide in its formulation, which prevents it from working with a low excess of steam in relation to the stoichiometry of the shift reaction, in order to gain energy efficiency in the H2 production process by steam reforming.

Thus, no prior art document discloses a high temperature water gas shift catalyst used in a carbon monoxide conversion process such as that of the present invention.

In order to solve such problems, the present invention was developed by providing HTS catalysts, free of chromium, iron and noble metals, which have high activity and resistance to thermal deactivation, that is, maintaining their activity for long periods, even when exposed to high process temperatures.

The reduction of excess steam in the CO conversion process, expressed by the steam/gas or steam/carbon ratio, is only possible by using iron-free HTS catalysts such as those obtained in the present invention. Furthermore, the elimination of chromium from the catalyst formulation, especially in its form of Cr⁶⁺ which is carcinogenic, minimizes risks during catalyst handling, loading and unloading steps.

In addition, the use of an HTS catalyst tolerant to low vapor/gas ratios reduces the risk of occurrences of abnormalities in the process, which could lead to increased head loss and/or formation of by-products in the reactor. Thus, the reduction of the steam/carbon ratio in the steam reforming process for the production of H2 contributes to the reduction of CO₂ emissions in the process, since the H₂ production process, together with the FCC process, are the two biggest emitters of CO₂ from refining.

### BRIEF DESCRIPTION

The present invention deals with a catalyst for converting CO by the reaction of water gas shift at high temperature, free of chromium and iron, consisting of alumina promoted by potassium and zinc oxide. The catalyst prepared in this way maintains a high CO conversion activity, not having the environmental or operation limitations with low excess steam in the process, as the state of the art catalysts.

Such a catalyst is used in the process of producing hydrogen or synthesis gas by steam reforming hydrocarbons, allowing the use of low steam/carbon ratios in the process, presenting high activity and stability to thermal deactivation and lower environmental restrictions of production, storage, use and disposal than catalysts used industrially based on iron, chromium and copper oxides.

### BRIEF DESCRIPTION OF DRAWINGS

The present invention will be described in more detail below, with reference to the attached figures which, in a schematic form and not limiting the inventive scope, represent examples of its realization. The drawings show:

FIG. 1 illustrates an X-ray diffraction (XRD) plot of the solids obtained in accordance with Examples 1 and 9;

FIG. 2 illustrates an X-ray diffraction (XRD) plot of solids obtained in accordance with Examples 10, 11 and 12, in accordance with the present invention.

### DETAILED DESCRIPTION OF THE INVENTION

The present invention relates to a catalyst applicable to the water gas displacement step of the steam reforming process to produce hydrogen. Such catalyst consists of a support of the potassium aluminate type containing zinc oxide as a promoter. The catalyst has a specific area greater than 60 m²/g, a potassium content between 4 and 15% m/m and a zinc oxide content between 10 and 30% m/m, based on the oxidized material, being obtained by method of preparation, comprising the following steps.
1. Impregnation of an alumina, selected from among boehmite, gamma or theta-alumina, with an aqueous solution of a potassium salt, preferably potassium hydroxide, carbonate or nitrate, followed by drying and calcination at temperatures between 400° C. and 800° C. to obtain an alumina promoted with potassium;
2. Impregnation of the potassium-promoted alumina-type support with a polar solution, preferably aqueous, containing a zinc salt, preferably zinc nitrate or carbonate, followed by drying, formatting into tablets and calcination at temperatures between 300° C. to 500° C., preferably between 350° C. and 450° C.

The term potassium-promoted alumina, as used in the present invention, refers to an alumina containing potassium species on its surface that may, depending on the calcination temperature, present, by the X-ray diffraction technique, crystalline structures of oxide aluminum and potassium, such as the form K₂O·Al₂O₃ (CAS 12003-62-3).

Alternatively, step 1 does not need to be performed, the commercial potassium aluminates may be used, provided they have a specific surface area greater than 15 m²/g, preferably greater than 40 m²/g. Aluminas that have greater resistance to the loss of specific surface area can also be used, in the presence of steam and at temperatures between 250° C. and 450° C., such as the aluminas promoted by lanthanum contents between 1 and 5% m/m.

The formatting step can be carried out by commercial machines, obtaining tablets, preferably with typical dimensions of 3 to 6 mm in diameter and height. Other formats can also be used, such as single cylinder or connected multiple cylinders (trilobe, quadralobe) or raschig rings. Alternatively, in step 1 an alumina, such as gamma or theta-alumina, already pre-formed can be used.

In an alternative way, the support is impregnated simultaneously with a potassium salt, preferably potassium hydroxide or nitrate, and a zinc salt, preferably zinc nitrate or carbonate, in a solution of a polar solvent, preferably water, followed by drying and calcination at temperatures between 400° C. to 800° C.

The catalyst thus prepared is active, stable and ready for use, not requiring any additional activation procedure, and can be used in the conversion reaction of CO with water vapor to produce hydrogen, at inlet temperatures of the reactor between 280° C. to 400° C., preferably at temperatures between 300° C. to 350° C. and of the reactor outlet between 380° C. to 500° C., preferably between 400° C. to 450° C. The operating pressure in the reactor can be in the range of 10 to 40 kgf/cm², preferably between 20 to 30 kgf/cm². The steam/dry gas molar ratio at the reactor inlet is preferably in the range of 0.05 to 0.6 mol/mol, more preferably in the range of 0.1 to 0.3 mol/mol. Equivalently, the vapor/carbon ratio (mol/mol) at the inlet of the primary steam reforming reactor, which precedes the high temperature water gas shift (HTS) reactor, is preferably in the range of 1 to 5 mol/mol, more preferably in the range of 1.5 to 2.5 mol/mol. The concentration of CO in the dry gas at the inlet of the conversion reactor is typically 5 to 30% v/v, preferably 8 to 20% v/v. [0030] A second aspect of the present invention is to provide an HTS catalyst that can be used with low excess steam, equivalent to a low steam/gas ratio at the inlet of the HTS reactor or a low steam/carbon ratio at the reactor inlet steam reforming, without formation of by-products or increase in head loss due to phase transformations of the material.

A third aspect of the present invention is to provide a carbon monoxide conversion process by placing said catalyst in contact with a stream of syngas at temperatures between 250° C. to 450° C., steam/gas between 0.2 to 1.0 mol/mol and pressures between 10 and 40 atm.

In accordance with the first aspect of the invention, a catalyst for use in the high temperature water gas displacement reaction (HTS) consisting of potassium aluminate (KAlO₂) promoted by zinc oxide (ZnO) is taught.

### A. EXAMPLES

The examples presented below are intended to illustrate some ways of implementing the invention, as well as to prove the practical feasibility of its application, not constituting any form of limitation of the invention.

### B. EXAMPLE 1

This comparative example illustrates the preparation of a catalyst, in accordance with the state of the art, for the high temperature water gas shift (HTS) of the zinc aluminate type promoted by alkali metals. Initially, by dissolving and stirring at room temperature, an aqueous solution containing 311 grams of demineralized water (H₂O), 415 grams of aluminum nitrate (Al(NO₃)₃·9H₂O, brand VETEC, PA) was prepared in a nominal ratio Zn/Al of 0.5 mol/mol.

Then the solution was swelled with demineralized water to 830 ml and had a pH of 1.04. Over this solution, an ammonium hydroxide solution (NH₄OH, 28% w/w, VETEC) was added at room temperature, in 30 minutes and with stirring at 300 rpm, until the pH of the stirred mixture was between 8.0 to 8.5. The mixture was stirred for 1 hour and then filtered and washed with demineralized water. The precipitated material was then dried at 110° C. for 12 hours and then calcined in static air at a temperature of 750° C. for 3 hours.

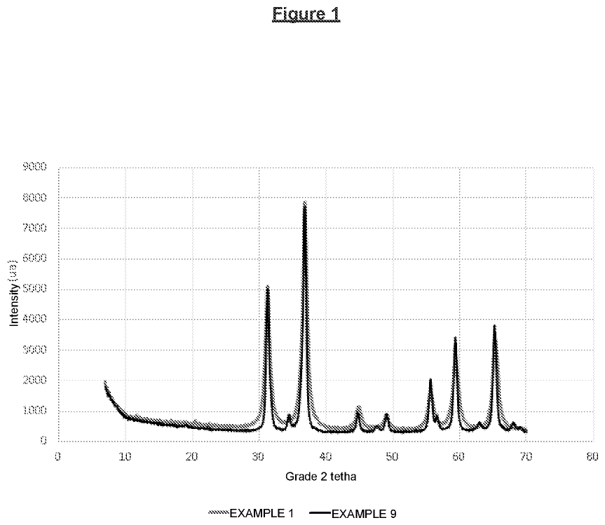

The characterizations of the material showed by the N2 adsorption technique (Brunauer-Emmett-Teller method—BET) a specific area of 65 m²/g, pore volume of 0.23 cm³/g and average pore diameter of 144 A; and by the X-ray diffraction technique (XRD, Cu—K radiation, 40 kV, 40 mA) the characteristic pattern of zinc aluminate (JCPDS Card No 05-0669), as shown in FIG. 1.

### C. EXAMPLE 2

This state of the art comparative example illustrates the preparation of a high temperature water gas shift (HTS) catalyst of the zinc aluminate type promoted by alkali metals. Ten grams of the material produced in EXAMPLE 1 was impregnated by the pore volume technique with 6.1 ml of an aqueous solution containing 0.145 grams of potassium hydroxide (VETEC). The material was dried at 100° C. for 1 hour and then calcined at 500° C. for 2 hours in order to obtain a zinc aluminate type catalyst promoted with 1% m/m of potassium. The product presented, by the N₂ adsorption technique, a specific area of 60.7 m²/g, pore volume of 0.24 cm³/g and average pore diameter of 144.6 A.

### D. EXAMPLE 3

This state of the art comparative example illustrates the preparation of a high temperature water gas shift (HTS) catalyst of the zinc aluminate type promoted by alkali metals. The preparation was identical to that used in EXAMPLE 2, varying the potassium hydroxide content in order to have a nominal content of 2% m/m of potassium. The product showed, by the N₂ adsorption technique, a specific surface area of 60.0 m²/g, pore volume of 0.24 cm³/g and average pore diameter of 143 A.

### E. EXAMPLE 4

This state of the art comparative example illustrates the preparation of a high temperature water gas shift (HTS) catalyst of the zinc aluminate type promoted by alkali metals. The preparation was identical to that used in EXAMPLE 2, varying the potassium hydroxide content in order to have a nominal content of 4% m/m of potassium. The product showed, by the N₂ adsorption technique, a specific surface area of 52 m²/g, pore volume of 0.22 cm³/g and average pore diameter of 151 A. EXAMPLE 5:

This state of the art comparative example illustrates the preparation of a high temperature water gas shift (HTS) catalyst of the zinc aluminate type promoted by alkali metals. The preparation was identical to that used in EXAMPLE 2, varying the potassium hydroxide content in order to have a nominal content of 8% m/m of potassium. The product showed, by the N₂ adsorption technique, a specific surface area of 42 m²/g, pore volume of 0.19 cm³/g and average pore diameter of 151 A. EXAMPLE 6:

This state of the art comparative example illustrates the preparation of a high temperature water gas shift (HTS) catalyst of the zinc aluminate type promoted by alkali metals. The preparation was identical to that used in EXAMPLE 2, changing the source of potassium to potassium carbonate (K₂CO₃) in order to have a nominal content of 4% m/m of potassium. The product showed, by the N₂ adsorption technique, a specific surface area of 39.0 m²/g, pore volume of 0.18 cm³/g and average pore diameter of 188 A.

### F. EXAMPLE 7

This comparative example illustrates the preparation of a high temperature water gas shift (HTS) catalyst of the zinc aluminate type promoted by alkali metals and in accordance with the state of the art. The material was prepared in a similar way to EXAMPLE 1, except that the proportions of the reagents were changed in order to have a Zn/Al ratio of 0.70 mol/mol.

The characterizations of the material showed a) by the N₂ adsorption technique a specific surface area of 22 m²/g, pore volume of 0.12 cm³/g and average pore diameter of 235; b) by the quantitative technique of X-ray Fluorescence (FRX) a composition containing 25% m/m of Al and 40% m/m of Zn, being the oxygen balance and by the technique of X-ray diffraction (XRD) the standard characteristic of zinc aluminate, as shown in FIG. 1.

### G. EXAMPLE 8

This state of the art comparative example illustrates the preparation of a high temperature water gas shift (HTS) catalyst of the zinc aluminate type promoted by alkali metals. Ten grams of the material produced in EXAMPLE 7 was impregnated by the pore volume technique with 4.0 ml of an aqueous solution containing 0.598 grams of potassium hydroxide (VETEC). The material was dried at 100° C. for 1 hour and then calcined at 500° C. for 2 hours in order to obtain a zinc aluminate type catalyst promoted with 4% m/m of potassium. The product showed, by the N₂ adsorption technique, a specific surface area of 16.7 m²/g, pore volume of 0.10 cm³/g and average pore diameter of 173 A.

### Example 9

This state of the art comparative example illustrates the preparation of a high temperature water gas shift (HTS) catalyst of the zinc aluminate type promoted by alkali metals. The preparation was identical to that used in EXAMPLE 8, varying the potassium hydroxide content in order to have a nominal content of 8% m/m of potassium. The product showed, by the N₂ adsorption technique, a specific surface area of 17.5 m²/g, pore volume of 0.08 cm³/g and average pore diameter of 176 A.

### H. EXAMPLE 10

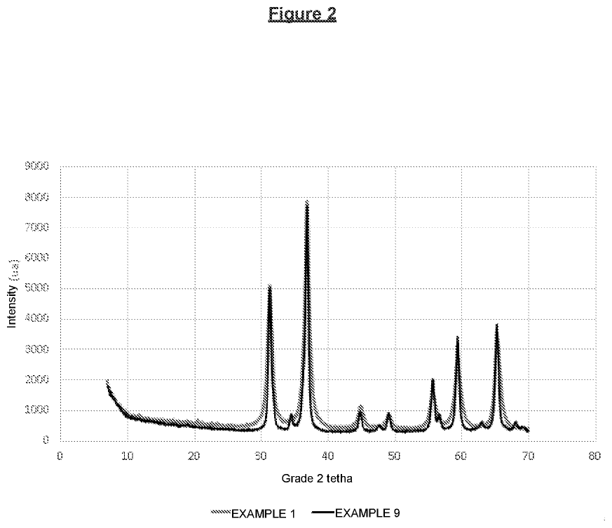

This example illustrates the preparation of a high temperature water gas shift (HTS) catalyst of the potassium and zinc oxide promoted alumina type in accordance with the present invention. One hundred grams of a commercial alumina hydroxide (boehmite, CATAPAL, SASOL) were impregnated by the wet spot method with a 70 ml aqueous solution containing 11.5 grams of potassium hydroxide (VETEC). The following material was dried at 100° C. for 12 hours and calcined in static air at a temperature of 600° C. for 2 hours to obtain a SUPPORT of the potassium-promoted alumina type, as shown in FIG. 2. The material had a specific surface area of 111 m²/g and pore volume of 0.27 cm³/g by the nitrogen adsorption technique (BET).

Fifteen grams of the support thus obtained were impregnated by the wet spot technique with 9.3 ml of aqueous solution containing 6.09 grams of zinc nitrate (Zn(NO₃)₂·6H₂O, Merck) and then dried at 100° C. for 12h and calcined in static air at a temperature of 400° C. for 2 hours, to obtain a material containing a nominal content of 8.0 m/m Zn (semi-quantitative analysis using the X-ray fluorescence technique showed a content of 7.1% m/m), a specific surface area of 89.5 m²/g and a pore volume of 0.21 cm³/g and without observing the significant presence of crystalline zinc aluminate by the X-ray diffraction technique, as illustrated in FIG. 2.

### L. EXAMPLE 11

This example in accordance with the present invention illustrates the preparation of a high temperature water gas shift (HTS) catalyst of the alumina type promoted with potassium and zinc oxide. Fifteen grams of the support obtained in EXAMPLE 10 were impregnated by the wet spot technique with 9.3 ml of aqueous solution containing 9.80 grams of zinc nitrate (Zn(NO₃)₂·6H₂O, Merck) and then dried at 100° C. for 12 hours and calcined in static air at a temperature of 400° C. for 2 hours, to obtain a catalyst containing a nominal content of 12.1% m/m of Zn (semi-quantitative analysis using the X-ray fluorescence technique showed a content of 10% m/m), a specific surface area of 86.1 m²/g and a pore volume of 0.19 cm³/g and without observing the significant presence of crystalline zinc oxide by the X-ray diffraction technique, as illustrated in FIG. 2.

### J. EXAMPLE 12

This example in accordance with the present invention illustrates the preparation of a high temperature water gas shift (HTS) catalyst of the alumina type promoted with potassium and zinc oxide. Fifteen grams of the catalyst obtained in EXAMPLE 10 were impregnated by the wet spot technique with 9.3 ml of aqueous solution containing 6.09 grams of zinc nitrate (Zn(NO₃)₂·6H₂O, Merck) and then dried at 100° C. for 12 hours and calcined in static air at a temperature of 400° C. for 2 hours, to obtain a catalyst containing a nominal content of 16.1% m/m of Zn, a specific surface area of 81.1 m²/g and a volume of pores of 0.19 cm³/g and without observing the significant presence of crystalline zinc oxide by the X-ray diffraction technique, as shown in FIG. 2.

### K. EXAMPLE 13

This example describes the catalytic activity measurement of the catalysts obtained in accordance with EXAMPLES 1 to 12. The shift reaction was carried out in a fixed bed reactor at atmospheric pressure. The sample was initially heated in an argon flow to 100° C. and then to 350° C., at a rate of 5° C./min in a flow of 5% H₂ in argon saturated with water vapor at 73° C. After this pre-treatment, the gaseous mixture was replaced by a mixture containing 10% CO, 10% CO2, 2% methane in H₂ balance, maintaining the temperature of the saturator with water at 73° C., corresponding to a ratio steam/gas of 0.55 mol/mol. The reaction was conducted at temperatures from 350° C. to 450° C. with the reactor effluent being analyzed by gas chromatography. The activity of the catalysts was expressed as CO conversion (% v/v).

The results are presented in Table 1 and allow the conclusion that the catalysts of the present invention have surface area and activity, measured by the conversion of CO in the water gas shift reaction, superior to those prepared in accordance with the state of the art. This superior performance is desirable in the industry as it allows the use of smaller volumes of catalysts and/or lower operating temperatures, both options with economic gains in the process.

TABLE 1
Activity in the water gas shift reaction (XCO) of HTS catalysts prepared in accordance
with the state of the art and in accordance with the present invention.

| | | | | | Temperature (° C.) | | | | |
|---|---|---|---|---|---|---|---|---|---|
| | | | | | 350 | 370 | 390 | 420 | 450 |
| | catalyst | | | | | | | | |
| | Zn/Al | S | K | Zn | X CO | X CO | X CO | X CO | X CO |
| | mol/mol | m²/g | % m/m | % m/m | % v/v | % v/v | % v/v | % v/v | % v/v |
| EXAMPLE 1: | 0.5 | 65.0 | 0.0 | 35.6 | 0.3 | 0.5 | 0.5 | 1.4 | 2.3 |
| EXAMPLE 2: | 0.5 | 60.7 | 1.0 | 35.2 | 0.2 | 1.4 | 1.9 | 3.1 | 3.5 |
| EXAMPLE 3: | 0.5 | 60.0 | 2.0 | 34.9 | 3.1 | 4.5 | 6.3 | 9.9 | 12.7 |
| EXAMPLE 4: | 0.5 | 52.0 | 4.0 | 34.2 | 4.5 | 6.4 | 9.7 | 16.0 | 22.9 |
| EXAMPLE 5: | 0.5 | 42.0 | 8.0 | 33.0 | 3.5 | 6.2 | 9.8 | 16.3 | 23.1 |
| EXAMPLE 6: | 0.5 | 39.0 | 4.0 | 34.2 | 3.2 | 6.1 | 9.2 | 15.8 | 23.3 |
| EXAMPLE 7: | 0.7 | 22.0 | 0.0 | 42.1 | 0.1 | 0.3 | 0.4 | 1.0 | 1.5 |
| EXAMPLE 8: | 0.7 | 16.7 | 4.0 | 40.5 | 3.1 | 5.7 | 9.7 | 17.0 | 27.2 |
| EXAMPLE 9: | 0.7 | 17.5 | 8.0 | 39.0 | 2.1 | 3.9 | 7.6 | 14.1 | 21.6 |
| EXAMPLE 10: | 0.1 | 111.0 | 9.0 | 8.0 | 1.4 | 2.0 | 16.2 | 26.6 | 29.6 |
| EXAMPLE 11: | 0.2 | 86.6 | 8.7 | 12.0 | 2.8 | 5.0 | 16.5 | 24.3 | 37.9 |
| EXAMPLE 12: | 0.3 | 81.1 | 8.5 | 16.0 | 5.4 | 12.9 | 23.0 | 32.0 | 38.3 |

It should be noted that, although the present invention has been described in relation to the attached drawings, it may present modifications and adaptations by skilled in the art, depending on the specific situation, but as long as it is within the inventive scope defined herein.

1. A method for preparing a water gas shift catalyst at high temperature comprising the following steps:
a) impregnating an alumina support with a polar solvent solution and a soluble potassium salt;
b) drying the support to remove the solvent and calcinating the support at temperatures between 400° C. and 800° C. to obtain an alumina promoted with potassium;
c) impregnating the potassium-promoted alumina with a polar solution containing a soluble zinc salt;
d) drying and calcinating the material at a temperature between 300° C. and 500° C., in which said catalyst has a specific area greater than 60 m²/g, a potassium content in the range of 4 to 15% m/m and a content of oxide zinc between 10 to 30% m/m and a Zn/Al ratio less than 0.4 mol/mol, based on the weight of the oxidized catalyst.

2. The method of claim 1, wherein the alumina support is impregnated simultaneously with a potassium salt and a zinc salt in solution of a polar solvent, followed by drying and calcinating at temperatures between 400° C. to 800° C.

3. The method of claim 1, wherein the calcination of step (d) occurs at a temperature between 350° C. and 450° C.

4. The method of claim 1, wherein the alumina is selected from boehmite, gamma, theta-alumina or lanthanum-promoted alumina.

5. The method of claim 1, wherein the potassium salt is selected from hydroxide, nitrate or carbonate.

6. The method of claim 1, wherein the zinc salt is nitrate or carbonate.

7. The method of claim 1, wherein the polar solvent is water.

8. A process to reduce the monoxide content of carbon, wherein the water gas shift reaction comprises contacting the catalyst of claim 1 with a stream of synthesis gas characterized in that the synthesis gas contains between 5 and 30% of CO, a steam/gas ratio dry between 0.05 to 0.6 mol/mol and an inlet temperature in the reactor between 280° C. to 400° C. and pressure between 10 to 40 kgf/cm².
